(19) United States
(12) Patent Application Publication
(10) Pub. No.: US 2026/0338389 A1
(43) Pub. Date: Oct. 29, 2026

(54) SPACE HEATING FILM

(71) Applicant: NEXGEN HEATING LIMITED, Southampton (GB)

(72) Inventors: Clive David OSBORNE, Andover (GB); Lisa Jane KINGSCOTT, Malmesbury (GB)

(73) Assignee: NEXGEN HEATING LIMITED, Southampton, HA (GB)

(21) Appl. No.: 19/107,912

(22) PCT Filed: Sep. 4, 2023
(86) PCT No.: PCT/EP2023/074127

§ 371 Date: Feb. 28, 2025

(30) Foreign Application Priority Data
Sep. 2, 2022 (GB) 2212834.2

(51) Int. Cl. F24D 13/02; H05B 3/36

(52) U.S. Cl. CPC F24D 13/024; H05B 3/36; H05B 2203/032

(57) ABSTRACT

A space heating film and a heating system including a space heating film are disclosed. The space heating film is configured for attaching to a wall of a building to heat the adjacent space. The film comprises an electrically insulating base layer; a heater layer comprising an electrically resistive heating material and at least one conductor element; and an electrically insulating cover layer. The base layer and cover layer comprise fire-resistant materials bonded to opposing faces of the resistive heating layer to provide a fire-resistant sandwich structure.

### CROSS-REFERENCE TO RELATED APPLICATION

This application is a national stage application, filed under 35 U.S.C. § 371, of International Patent Application PCT/EP 2023/074127, filed on Sep. 4, 2023, which claims the benefit of UK Patent Application GB 2212834.2, filed on Sep. 2, 2022.

### TECHNICAL FIELD

The present disclosure relates to a space heating film and a heating system including a space heating film.

### BACKGROUND

Space heating in buildings, whether domestic or commercial, can be conducted in a large number of ways. For example, domestic housing often has a central heating system in which a boiler (typically gas fired) heats water which is distributed to radiators within each room to provide radiant heating to the space within the room. Additionally or alternatively, local heating sources may be provided which can include a fire or stove and or electrical resistive space heaters. Increasingly, alternate heat systems are being used to provide improved efficiency and/or move away from fossil fuels. As such, there is increased demand for electrically powered heating systems since they can for example be easily powered by renewable energy sources such as solar panels. An example of electrically powered heating systems are air or ground heat pumps but typically such systems are relatively slow to heat an area.

There remains a need for improved space heating arrangements which can provide a versatile and/or efficient and/or easy to install heating system. In particular there is a desire for electrical heating systems which can be used in combination with green energy sources such as a local solar panel installation. Embodiments of the space heating film seek to provide such a heater and heating system.

### SUMMARY

According to a first aspect, there is provided a space heating film for attaching to a wall of a building to heat the adjacent space. The film comprises an electrically insulating base layer; a heater layer comprising an electrically resistive heating material and at least one conductor element; and an electrically insulating cover layer. The base layer and cover layer comprise fire-resistant materials bonded to opposing faces of the resistive heating layer to provide a fire-resistant sandwich structure.

Advantageously, the fire-resistant sandwich structure of embodiments of the space heating film may provide a heating film which is an inherently low risk installation. As such, the film can be installed without additional steps being required (such as applying a separate fire-resistant coating over the film). The film of embodiments may accordingly be installed in a variety of different applications and environments without compromising fire safety.

Advantageously, the sandwich structure of embodiments may also provide a heating film which is waterproof. In particular the use of a film or non-woven fabric film bonded together with an adhesive provides a construction which is water resistant.

A space heating film in accordance with embodiments may be a relatively thin and generally flexible sheet. In some embodiments the film may be initially flexible but may become stiff or hard as adhesives used therein cure. The film may be attached in use to a suitable substrate to heat the adjacent area. The substrate is conveniently referred to herein as a wall and it will be understood that this also includes ceilings and floors which bound a space to be heated. Embodiments of the space heating film may provide a flexible solution which can be attached to any suitable surface. Thus, it may be appreciated that in the present context embodiments of the space heating film provide a film which is suitable for attaching to a wall of a building but which may also have other uses in which a film is attached to a substrate to heat the adjacent space (but differs from for example prior art dedicated underfloor heating mats and the like which are only suitable for floor installation). Applications of the space heating film may include ceilings and walls. As embodiments may use a low voltage supply, they may be suitable for both internal and external use. For example embodiments could be provided on or under a substrate to provide de-icing.

Advantageously a thin film-based heating arrangement enables a large area of a room to be easily covered. When a large area or proportion of the surfaces surrounding a room are covered it is possible to provide an effective heating effect with only a small temperature difference above ambient temperatures. In contrast a local heating source such as a conventional radiator must be heated significantly above ambient temperature to have sufficient effect on the overall temperature of the room. Advantageously the use of a relatively low temperature heat source (which may be enabled by the large surface area) a higher proportion of heat energy emitted would be infrared radiation than in conventional heat sources (including those which are marketed as infrared heaters). An increased proportion of infrared radiation is desirable as it provides a faster warming feeling/effect on humans than increasing air temperature for a lower energy usage.

The base layer may define a wall facing side of the film. The cover layer may define a space facing side of the film. The cover layer may be a film or a fabric. The base layer may be a film or fabric. The cover layer may include a decorative outer surface. The base layer and/or cover layer may comprise a plurality of sub layers. For example, the cover layer could include a first sub-layer which is selected for its insulative properties covered by a second sub-layer which provides an aesthetic finish (for example a decorative layer or a layer which provides a suitable surface for painting).

The base layer may include an adhesive layer (for example a self-adhesive layer with a removable film backing) for attaching the space heating film to the substrate. The adhesive may be a pressure sensitive adhesive layer.

To provide a fire-resistant material the base layer and cover layer may be formed from a non-flammable material. Suitable materials may for example be selected from aramid, glass fibre or polyimide materials.

Additionally or alternatively, the base layer and cover layer may comprise a fire suppressant. The fire suppressant may be an additive incorporated into the material of the respective layer. In some embodiments the layers may be polyester and may comprise phosphate esters as a fire suppressant. The fire suppressant may include an intumescent material, for example an external layer of intumescent material. The inclusion of a layer of intumescent material may advantageously enhance the fire suppression and fire spread rating of the film.

In some embodiments the combination of material and fire suppressant may include one or more of: Polypropylene with phosphate esters, or Borax; Polyamide with phosphate esters, or Borax; Cotton or flax soaked in a borax or other proprietary fire suppressant chemical solution and dried; Cotton or flax treated with Methylene diphenyl diisocyanate (MDI), citric acid (CA) as a cross-linker, and 3-(dimethylphosphono)-N-methylolpropionamide (MDPPA) as a fire-retardant agent. Some embodiments may utilise epoxy (including pre-preg materials including epoxy) with a fire suppressant additive.

The layers of the film may be bonded with an adhesive. The film may, for example, further comprises a first and second adhesive layers disposed respectively between the heater and the base layer and cover layer. The film may for example be hot laminated to bond the adhesive layers. Accordingly, the adhesive may be a thermal adhesive. The hot lamination may melt the adhesive and compress (for example between rollers) the sandwich structure of the film together. The adhesive may at least partially impregnate the electrically resistive heating layer. The adhesive may also ensure good contact between the electrically resistive heating layer and at least one conductor element.

To further enhance the fire resistance of the space heating film, the adhesive may be a fire-resistant adhesive. For example, the adhesive may be a non-flammable polymer. The adhesive may additionally, or alternatively, comprise a comprise fire suppressant additives.

The least one conductor element may comprise a conductive ribbon. The conductive ribbon may extend lengthwise along the film. The conductive ribbon may for example be metallic for example copper or aluminium foil ribbon. In other embodiments the conductive element may be a highly conductive region of high-density carbon fibres. The at least one conductor element may comprise a plurality of spaced apart conductive ribbons. For example, a pair of ribbons may be spaced apart across the width of the film. The plurality of ribbons may extend parallel to one another along the length of the film. The pair of ribbons may each be positioned adjacent to a side edge of the film.

The resistive heating material may comprise a composite fabric. For example, the resistive heating material may comprise conductive carbon elements embedded in a matrix material. It will be appreciated that a range of conductive carbon elements are available and include, without limitation, carbon fibres, carbon nano-tubes and carbon nano-spheres.

The matrix of the resistive heating material may be provided as a pre-preg type material (in which the conductive carbon elements may be pre-encapsulated in a sheet of matrix material) or may be formed in situ during the manufacturing process (for example the material of the base or cover layer may impregnate the carbon during manufacture to form the matrix material of the final composite. The matrix material may be a thermoplastic polymer. A thermoplastic polymer may be advantageous in providing rapid manufacture as it may be melted to bond the layers of the space heating film and/or to embed the conductive elements. Particularly when higher operating temperatures are required, alternatively the matrix may be a thermoset polymer.

In a particular embodiment the resistive heating material may comprise polymer (for example polyethylene) carbon nanofibre composite.

In some embodiments the resistive heating material could comprise a graphene material, for example a laser induce graphene. A laser induced graphene can for example be formed on a sheet of plastic film (for example polyimide) which is irradiated with a computer-controlled laser. One potential advantage of a laser induced graphene resistive heating material is that the at least one conductor element may be formed integrally with the heating material. For example, the higher density regions of carbon/graphene may be laser formed. Alternatively or additionally, compounds as silver or copper fulminate or others may be selectively included in the film. When treated with the laser, the silver or copper fulminate can be converted to native silver or copper particles within the carbon/graphene on the film surface.

In other embodiments the resistive heating material could comprise a resistive deposition on a film (for example a plastic film). For example, the resistive heating material may comprise a carbon containing ink printed on a film. Alternatively, the resistive heating material may comprise a metal alloy deposition, for example a metal alloy particles may be deposited in an ink or an evaporation coating.

The properties of the resistive heating layer may be optimised. For example, depending on the composition of the resistive layer, the size and density of conductive fibres or particles and the proportion of non-conducting filler components can be selected to tailor the properties. For example, in some embodiments the resistance may be constant throughout the resistive heating layer. In other embodiments it may be beneficial to have a positive or negative temperature coefficient (such that the resistance can increase or decrease with temperature).

The cover layer may further comprise a coating which enhances the production of far infrared radiation. The provision of such a coating provides an enhanced feeling of warmth to the end user due to human skin heat absorption and perception. Such far infrared emission coatings are available for example as a paint. The coating may include tourmaline and/or metal oxides and/or ceramic powders.

The space heating film may include at least one terminal (and typically a plurality of terminals) for connecting the resistive heater to a power supply. The terminal(s) may comprise a toothed crimp. The toothed crimp may be arranged to pierce the cover layer of the film to form an electrical connection with the conductor element. The toothed crimp may for example comprise a plurality of teeth which each pierce the cover layer and make a connection to the conductor element. Such embodiments may, for example, provide an arrangement in which the terminals can be readily positioned during installation after the film is attached to the wall.

According to further aspects there is provided a heating system comprising a space heating film according to embodiments and further comprising a power supply and a controller. The power supply provides a voltage of less than 50V AC or less than 120V DC. Such low voltage power supplies are advantageous in providing increased safety to the end user without increased need for electrical insulation. This can be particularly beneficial to a wall heating system in reducing or removing risks which may be caused by users piercing the film with nails, screws or other fixings which are common place in homes and the like. Further, in most countries regulations recognise “low voltage” systems as safer meaning they are easier to implement.

Advantageously, embodiments of the space heating film can be adjusted for different operating voltages by adjusting the resistance of the electrically resistive heating material and/or by adjusting the configuration of the at least one conductor element.

In applications where a higher voltage system is used, it may be possible to operate the system direct from mains power such that a separate power supply is not needed. A higher voltage system would have a higher resistance layer of electrically resistive heating material and may require increased electrical insulation. As such the insulating layers may have increased thickness. Additionally a high voltage product may require additional insulation applied to the edges of the heating film. For example, such embodiments may comprise an additional insulative coating applied over any cut edges. Alternatively or additionally, embodiments may comprise a plurality of insulating layers (for example forming the outer layer). Similarly, such embodiments may also require insulated electrical crimp connections (for example comprising moulded covers or a low pressure in situ injection moulding).

The heating system may further comprise a thermally insulating layer disposed between the space heating film and the supporting wall. The inclusion of a thermally insulating layer is advantageous in increasing the speed at which the heating effect of the system has effect within the adjoining space by reducing the initial absorption of heat by the wall to which the heating film is attached. This is, for example, important as most buildings include materials (such as brick or concrete) which have a high heat capacity so could absorb significant heat before the film could radiate sufficient heat into the room. Typically, the insulation layer may be thin, for example less than 10 mm and more particularly between 3 to 5 mm. In embodiments the thermally insulating layer may comprise vacuum insulation panels. It may be appreciated that vacuum insulation panels (which comprise a rigid thermal insulation panel evacuated and vacuum-sealed within a gas-tight film) have a high thermal efficiency such that a thinner insulating layer may be possible than with other insulating materials.

A heating system in accordance with embodiments may use an insulating layer which is separately installed. Advantageously, however, in some embodiments the insulating layer and space heating film comprise an integrally formed panel. This may for example simplify installation of the heating system.

An integral formed panel may, for example, be manufactured as a unitary product. For example, the layers of the film could be laid up in a mould prior to the introduction of an insulation material (for example a foam). In such an arrangement the insulation material could provide adhesive properties to the film and could provide pressure to bond the film. In such an arrangement the electrically insulating base layer could be formed by the insulation material. Alternatively, the electrically insulating base layer could be a permeable layer which bonds with the insulating material.

To aid installation of the system it may be beneficial to provide insulating filler panels which can be installed alongside panels in accordance with embodiments to ensure that a flat finished surface is easily achieved (whilst also enhancing the overall thermal efficiency of the room). Accordingly, in some embodiments there is provided a heating system comprises a plurality of panels, the plurality comprising at least one integrally formed panel and at least one passive insulating panel, the plurality of panels having a matched thickness.

Such an arrangement is considered to be advantageous in its own right. Accordingly in another aspect there is provided a wall mountable heating system comprising a plurality of panels, the plurality of panels comprising: at least one passive insulating panel; and at least one active heating panel, comprising an insulating layer and an electrically resistive film heater; wherein the plurality of panels are installed side-by-side on a wall to provide a continuous outer surface. Both types of panel may have the same thickness such they can be installed together and provide a flat surface facing the room.

The electrically resistive film heater may comprise an electrically resistive heating layer and at least one conductor element. The electrically resistive film heater may; further comprise an electrically insulating cover layer. The electrically resistive film heater may be a space heating film according to any embodiments of the space heating film.

The active heating panel may further comprise a power supply and a controller.

A panel in accordance with some embodiments may further comprise a hard shell. A hard, or rigid, shell may for example be formed by a fibreglass and epoxy outer layer. This may for example be advantageous for use in areas where fixings (such as a shelf mountings) may be required. The use of a shell formed in this manner may for example be advantageous over the use of a conventional gypsum board which would slow down the warming time. The shell layer may for example be formed as a rear substrate of the film. The shell layer may for example be a fibre reinforced composite such as a glass fibre reinforced composite. The composite may comprise an epoxy or polyester layer, which will set hard, either by heating or at room temperature over an extended time. It may be appreciated that such panels could be manufactured as individual panels or batches in a mould; for example, the heating film layers may be first stacked and then liquid epoxy and fibre layer or prepreg placed in the mould. Subsequently a foaming insulation liquid could be introduced to the mould. Finally a curing step may be carried out. It may also be appreciated that the moulding process could be carried out in a continuous sheet manufacturing system.

In some embodiments the power supply and/or the controller may be provided in the insulating layer. This provides a particularly compact configuration and may remove the need for mounting separate control components. In some embodiments the system may further comprise storage batteries within the insulating layer. Such storage batteries can for example be useful in storing solar (or other renewable) generated energy to be used for heating at a different time.

Whilst the invention has been described above, it extends to any inventive combination of the features set out above or in the following description or drawings.

### BRIEF DESCRIPTION OF THE DRAWINGS

Embodiments of the invention may be performed in various ways, and embodiments thereof will now be described by way of example only, reference being made to the accompanying drawings, in which:

FIG. 1 shows a partially exploded view of a space heating film in accordance with an embodiment;

FIG. 2 shows an exploded cross section of the space heating film of FIG. 1;

FIG. 3 shows a cross-sectional view of an integrally formed heating panel according to an embodiment;

FIG. 4 shows a heating system having at least an insulating panel and an active heating panel;

FIGS. 5A and 5B show a toothed crimp terminal for use in embodiments;

FIG. 6 shows an alternate terminal for use in embodiments; and

FIG. 7 shows an insulated terminal for use in embodiments.

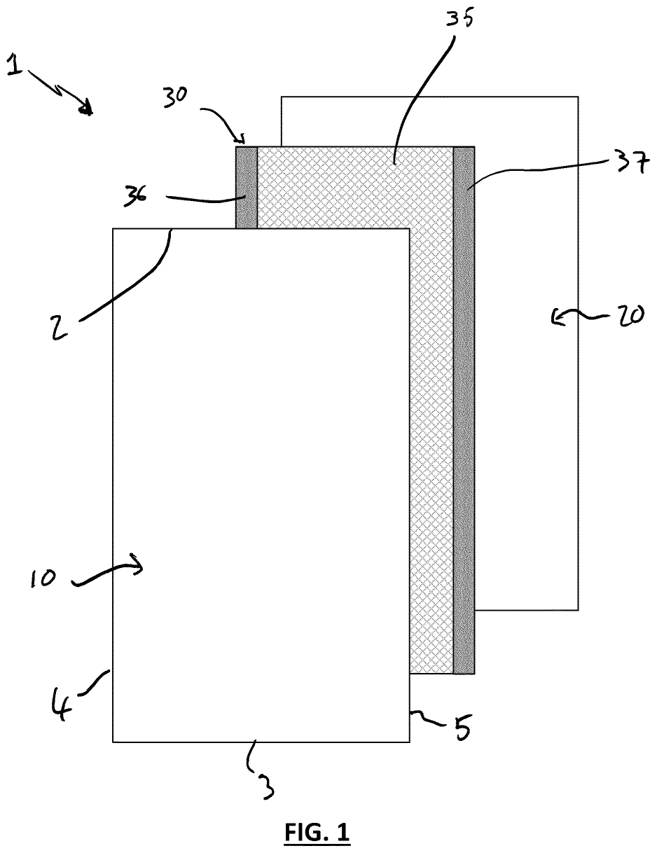

### DETAILED DESCRIPTION

In embodiments of the invention there is provided a space heating film 1 for attaching to a wall of a building to heat the adjacent space. The film comprises a laminar structure comprising a sandwich arrangement of a resistive heater layer 30 between electrically insulating cover layer 10 and base layer 20. The space heating film 1 is typically provided as an elongate sheet extending longitudinally from a first end 2 to a second end 3 and having a width extending between opposing sides 4, 5. The film may be supplied in a length which is sufficiently to cover the full height of a typical wall and the width may be such that a number of films are positioned side-by-side to cover a selected wall. Conveniently the film 1 may be initially supplied as a roll. The base layer 20 is arranged to be bonded to a wall (or other substrate) in use and may be applied to the wall using an adhesive or may have a self-adhesive backing. The self-adhesive backing could for example be a peel off layer or an “iron on” heat activated layer (and it will be appreciated that a heat activated layer must have an activation temperature which is sufficiently removed from the normal operating temperature of the film). The cover layer 10 may have a decorative finish or may be suitable for painting.

The heater layer 30 is sandwiched between the upper layer 10 and base layer 20 and includes a resistive heating material 35 and a pair of conductor ribbon strips 36 and 37. The ribbon strips 36, 37 are formed of a metallic conductor such as copper and each extend parallel to one another along substantially the full length of the heating film 1 (from the first end 2 to the second end 3). It can be noted that the conductor ribbons 36, 37 are each positioned proximal to one of the sides 4, 5 of the film 1 and the corresponding sides 31, 32 of the heater layer 30.

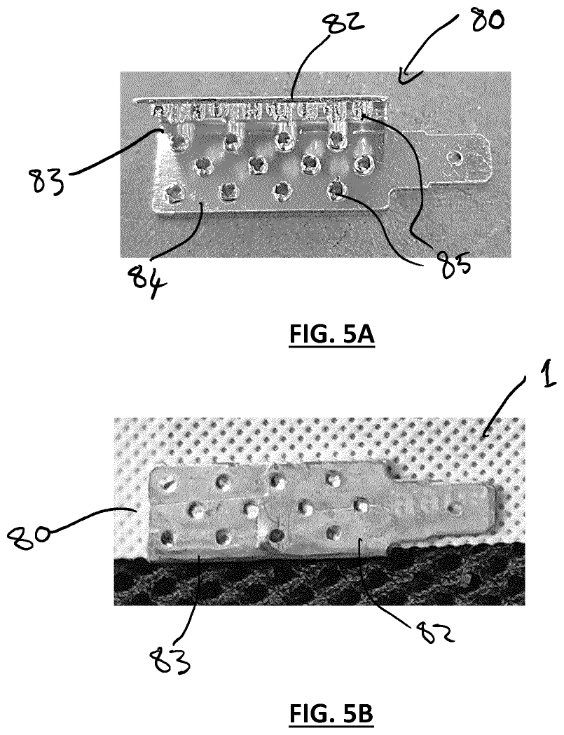

In embodiments, the resistive heating material 35 is a composite polyethylene nanocomposite. Such a composite includes conductive carbon fibres and is a lightweight material with fast temperature response. The heating material is provided with power from a supply (shown for example in FIG. 3) via terminals which may be toothed crimps which penetrate through the outer layers of the film 1 to form an electrical contact with the conductor ribbons 36, 37. The terminals are described in further detail below with respect to FIGS. 5 to 7. A controller may include a thermostatic control and may also communicate with a centralised heating control (for example one which accepts user inputs). Typically, the heater is powered by a low voltage supply (for example less than 50V AC or less than 120V DC) as this provides an arrangement which has good safety and will not present a risk in the event of damage to, or penetration through, the insulating layers 10, 20.

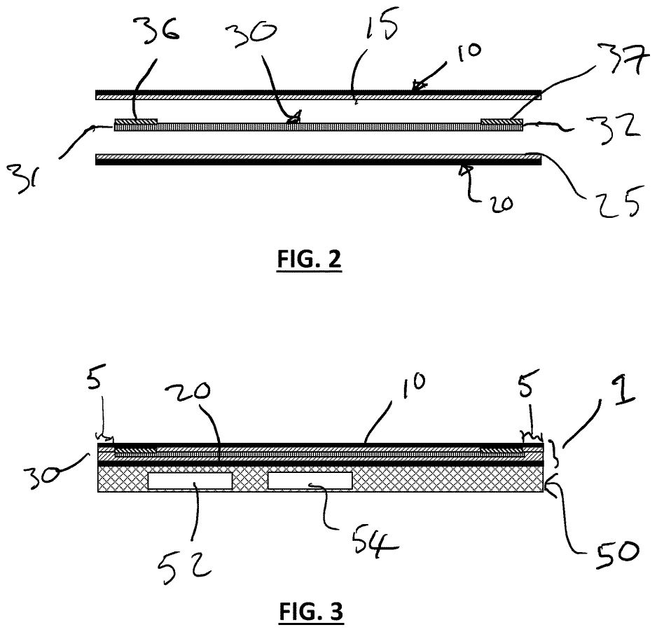

FIG. 2 shows a partially exploded cross section through the film 1 (and it will be appreciated that the thickness of each layer in this schematic is purely illustrative and for the ease of understanding). It can be noted that the cover layer 10 and base layer 20 are each provided with an adhesive layer 15 and 25. The adhesive layers 15, 25 may be heat activated adhesive. The adhesive 15, 25 can be activated in a hot roller lamination method which ensures that the layers of the film 1 are compressed together as the film is bonded. As such, it will be appreciated that the heater material 35 can become impregnated with adhesive and the ribbon strips 36, 27 can be bonded into place with the heater material 35 to ensure it is in good electrical contact therewith.

As shown in FIG. 3 in some embodiments the film 1 may be combined with a thermal insulator 50 backing sheet to form a prefabricated integral panel. This provides a ready to install heating system which is easy to install. The insulator 50 is attached to the rearward face of the film 1 and ensures that the heating effect in use primarily results in radiation from the cover side 20 and not heat absorption by the wall to which the panel is attached. The insulator 50 may be a vacuum insulation panel which provides particularly high thermal performance for a given thickness (and it will be appreciated that the relative thickness in the figure is for reference only). Conveniently, other components of the heating system such as a controller 52 and/or a power supply 54 may be located within the insulator layer 50. This enables the components to be installed without the need for an externally visible housing or cover.

It may be noted from FIGS. 2 and 3 that the heater layer 30 may have a reduced width in comparison to the film 1. In particular the sides of the heater layer 30 coincide with the outer edges of the conductive strips 36, 37. This provides an insulated peripheral strip 6, 7 adjacent to each respective edge 4, 5 of the film 1. This ensures that the heater 30 is insulated at the sides and is particularly convenient when heater films are installed in a side-by-side array (for example in a wallcovering).

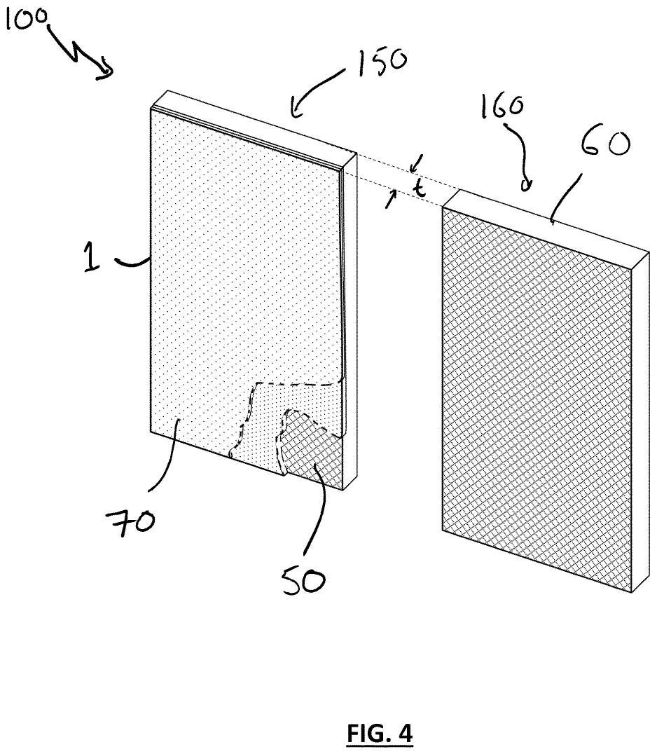

FIG. 4 schematically shows (with exaggerated thickness for illustrative purposes) a wall mountable heating system 100 of an embodiment which includes a mixture of active heating panels 150 and passive insulating panels 160. The active heating panel 150 may be of the type shown in FIG. 3 and has a film 1 in accordance with embodiments backed with an insulating layer 50 (shown in the partial cut-away). The passive panel 160 comprises only an insulating layer 60. The thickness “t” of the panels 150 and 160 is the same. Accordingly the panels 150, 160 can be installed side-by-side on a wall and provide a flat external surface facing the room. When installing a heating system in accordance with this embodiment it will be appreciated that the installer can select the appropriate number and position of active heating panels 150 and use passive panels 160 to then fill any remaining wall space such that a flat final wall surface is achieved. This provides a modular approach which is highly flexible and easy to use installation and can be rapidly configured to suit any specific requirements.

FIG. 5 shows an example of a terminal arrangement for use in embodiments. The terminal 80 comprises a toothed metal crimp connector which is initially in an open configuration and comprises opposed faces 82, 84 which are pivotally connected by a hinge 83 along a common side. The faces 82, 84 includes a plurality of teeth 85 which are formed by punched holes in the face. As shown in FIG. 5B in use the crimp connector can form a terminal on the film 1 by being positioned in a selected position and folded closed. The teeth 85 of the crimp connector 80 penetrate the insulating layers 10, 20 of the film to form an electrical connection.

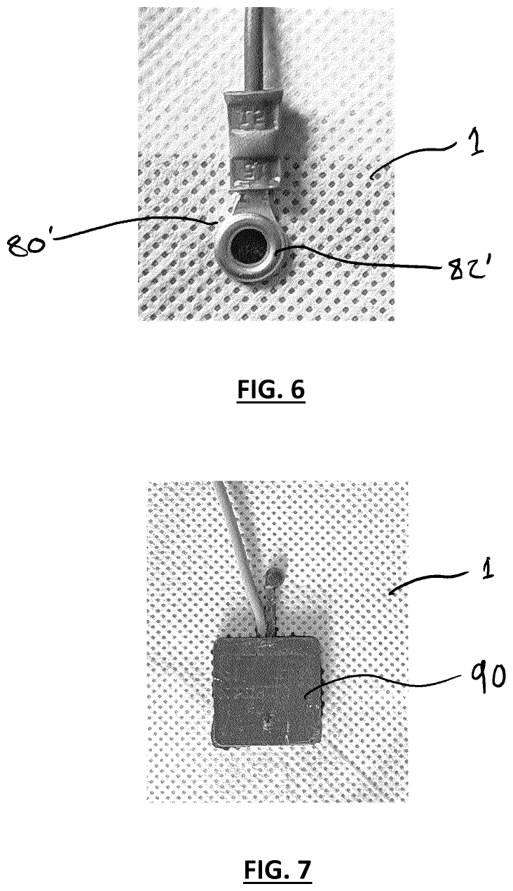

An alternate terminal 80′ is shown in FIG. 6. In this embodiment the crimp connector is provided in the form of an eyelet connector 82′. The eyelet 82′, which is formed of conductive metal such as copper, penetrates through the film 1 to form an electrical connection. The terminal may be overmoulded with an insulating material 90 such a plastic as shown in FIG. 7. The overmoulding of the plastic 90 may also help reinforce the attachment between the terminal 80 and the film 1. Advantageously, when overmoulding the insulating material, the plastic flows through the hole in the eyelet 82′ of the crimp and attaches the terminal to both sides of the film 1 in a single quick operation.

Although the invention has been described above with reference to preferred embodiments, it will be appreciated that various changes or modification may be made without departing from the scope of the invention as defined in the appended claims.

For example, as shown in FIG. 4, embodiments of the space heating film may also be provided with an outer hard shell 70 such as an epoxy glass fibre coating. The hard shell 70 may, for example, be useful in situations where fixtures and fittings may need to be attached to the wall after mounting of the heating system.

Further whilst the illustrated embodiment shows a single heater layer 30 extending along the length of a heating film 1 it may be appreciated that in some embodiments a series of heaters could be provided in a film with insulating gaps therebetween. Such an arrangement may provide convenient pre-determined cutting locations to allow the length of the film to be altered whilst maintaining insulation of the heating layer. This may for example enable a roll of heating film to be provided which can be cut into sections to provide a plurality of space heating films when installed (in a similar manner to a roll of wall paper).

1. A space heating film for attaching to a wall of a building to heat an adjacent space, the space heating film comprising:
an electrically insulating base layer;
a heater layer comprising an electrically resistive heating material and at least one conductor element; and
an electrically insulating cover layer,
wherein the electrically insulating base layer and the electrically insulating cover layer comprise fire-resistant materials bonded to opposing faces of the heater layer to provide a fire-resistant sandwich structure.

2. The space heating film as claimed in claim 1, wherein the cover layer further comprises a coating which enhances a production of far infrared radiation.

3. The space heating film as claimed in claim 1, wherein the electrically insulating base layer defines a wall facing side of the space heating film and the cover layer defines a space facing side of the space heating film.

4. The space heating film as claimed in claim 1, wherein the electrically insulating base layer and the electrically insulating cover layer are formed from a non-flammable material.

5. The space heating film as claimed in claim 1, wherein the electrically insulating base layer and the electrically insulating cover layer each comprise a fire suppressant.

6. The space heating film as claimed in claim, 1, further comprising first and second adhesive layers disposed respectively between the heater layer and the electrically insulating base layer and the electrically insulating cover layer.

7. The space heating film as claimed in claim 6, wherein the space heating film is hot laminated to bond the first and second adhesive layers.

8. The space heating film as claimed in claim 6, wherein the first and second adhesive layers comprise a fire-resistant adhesive.

9. The space heating film as claimed in claim 1, wherein the at least one conductor element comprises a conductive ribbon extending lengthwise along the space heating film.

10. The space heating film as claimed in claim 9, wherein the at least one conductor element comprises a pair of spaced apart conductive ribbons.

11. The space heating film as claimed in claim 1. further comprising
a terminal for connecting the heater layer to a power supply,
wherein the terminal comprises a toothed crimp which pierces the cover layer of the space heating film to form an electrical connection with the conductor element.

12. A heating system, comprising:
the space heating film according to claim 1;
a power supply; and
a controller.

13. The heating system according to claim 12,
wherein the power supply provides a voltage of less than 50V AC or less than 120V DC.

14. The heating system according to claim 13, further comprising
a thermally insulating layer disposed between the space heating film and the wall.

15. The heating system as claimed in claim 14,
wherein the thermally insulating layer comprises vacuum insulation panels.

16. The heating system as claimed in claim 14,
wherein the thermally insulating layer and the space heating film comprise are part of an integrally formed panel.

17. The heating system as claimed in claim 16,
wherein the heating system comprises a plurality of panels,
wherein the plurality of panels comprises at least one integrally formed panel and at least one passive insulating panel, and
wherein the plurality of panels have a matched thickness.

18. The heating system as claimed in claim 16,
wherein the integrally formed panel further comprises a hard shell.

19. The heating system as claimed in claim 16
wherein the power supply, the controller, and/or batteries are provided within the insulating layer.

20. A wall mountable heating system, comprising a plurality of panels, the plurality of panels comprising:
at least one passive insulating panel; and
at least one active heating panel, comprising an insulating layer and an electrically resistive film heater,
wherein the plurality of panels are installed side-by-side on a wall to provide a continuous outer surface.

21. The wall mountable heating system of claim 20,
wherein the electrically resistive film heater comprises
an electrically resistive heating layer,
at least one conductor element, and
an electrically insulating cover layer.

22. The wall mountable heating system of claim 20,
wherein the active heating panel further comprises a power supply and a controller.

23. The wall mountable heating system of claim 20,
wherein the plurality of panels have equal thickness.
